(19) United States
(12) Patent Application Publication
(10) Pub. No.: US 2026/0086950 A1
(43) Pub. Date: Mar. 26, 2026

(54) SYSTEMS AND METHODS FOR REGION-BASED PROBE FILTER SHOOTDOWN

(71) Applicant: Advanced Micro Devices, Inc., Santa Clara, CA (US)

(72) Inventors: Ganesh Balakrishnan, Austin, TX (US); Vydhyanathan Kalyanasundharam, Santa Clara, CA (US); Amit P. Apte, Austin, TX (US)

(73) Assignee: Advanced Micro Devices, Inc., Santa Clara, CA (US)

(21) Appl. No.: 18/896,750

(22) Filed: Sep. 25, 2024

(51) Int. Cl. G06F 12/0891; G06F 12/0817

(52) U.S. Cl. CPC G06F 12/0891; G06F 12/0817

(57) ABSTRACT

A computing system includes a first and second processing nodes each including one or more processors and a cache subsystem, and a probe filter directory having a directory entry for tracking cached data from a region of the memory, and a probe filter controller configured to automatically evict the first processing node from the directory entry in order to track the second processing node in the directory entry in response to the second processing node accessing the cached data, wherein the directory entry tracks only one processing node at a time. Various other methods and systems are also disclosed.

### BACKGROUND

Computer systems use main memory that is typically formed with inexpensive and high density dynamic random access memory (DRAM) chips. However, DRAM chips suffer from relatively long access times. To improve performance, a computer system typically includes at least one local, high-speed memory known as a cache. In a multi-core data processor, each data processor core can have its own dedicated level one (L1) cache, while other caches (e.g., level two (L2), level three (L3)) are shared by data processor cores.

Cache subsystems in a computing system include high-speed cache memories configured to store blocks of data. As used herein, a “block” is a set of bytes stored in contiguous memory locations, which are treated as a unit for coherency purposes. As used herein, each of the terms “cache block”, “block”, “cache line”, and “line” is interchangeable. In some examples, a block can also be the unit of allocation and deallocation in a cache. The number of bytes in a block is varied according to design choice, and can be of any size. In addition, each of the terms “cache tag”, “cache line tag”, and “cache block tag” is interchangeable.

In multi-node computer systems, special precautions must be taken to maintain coherency of data that is being used by different processing nodes. For example, if a processor attempts to access data at a certain memory address, it must first determine whether the memory is stored in another cache and has been modified. To implement this cache coherency protocol, caches typically contain multiple status bits to indicate the status of the cache line to maintain data coherency throughout the system. One common coherency protocol is known as the “MOESI” protocol. According to the MOESI protocol, each cache line includes status bits to indicate which MOESI state the line is in, including bits that indicate that the cache line has been modified (M), that the cache line is exclusive (E) or shared (S), or that the cache line is invalid (I). The Owned (O) state indicates that the line is modified in one cache, that there may be shared copies in other caches and that the data in memory is stale.

Probe filter directories are a key building block in high performance scalable systems. A probe filter directory is used to keep track of the cache lines that are currently in use by the system. A probe filter directory improves both memory bandwidth as well as reducing probe bandwidth by performing a memory request or probe request only when required. Logically, the probe filter directory resides at the home node of a cache line which enforces the cache coherence protocol. The operating principle of a probe filter directory is inclusivity (i.e., a line that is present in a central processing unit (CPU) cache must be present in the probe filter directory). The size of the probe filter directory increases linearly with the total capacity of all of the CPU cache subsystems in the computing system. Over time, CPU cache sizes have grown significantly. As a consequence of this growth, probe filter directory has become very large.

A region-based probe filter directory tracks cached memory by regions, hence reduces storage requirement in comparison with a line-based probe filter directory which tracks cached memory by lines. However, region-based probe filter directory is less capable of tracking a shared region, especially when different processing nodes access different lines of the region in a false sharing case. The false sharing causes significant probe amplification as superprobes are amplified at a per tracker granularity. The false sharing also sets multiple sector valid bits that causes further child probes from the superprobe amplification (e.g., each processing node has to be probed).

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary computing system.

FIG. 2 is a block diagram of an exemplary core complex.

FIG. 3 is a block diagram of an exemplary multi-CPU system.

FIG. 4 is a block diagram of an implementation of a probe filter.

FIG. 5 is a block diagram of another implementation of a probe filter.

FIG. 6 is a block diagram of an implementation of a region-based probe filter directory.

FIG. 7A is a flowchart illustrating an exemplary process for constructing a probe filter directory entry.

FIG. 7B is a block diagram illustrating changing contents of a region-based probe filter directory entry in response to node accesses shown in FIG. 7A.

FIG. 8 is a flowchart illustrating another exemplary process for constructing a probe filter directory entry.

FIG. 9 is a flowchart illustrating an exemplary process for maintaining a directory entry in a region-based probe filter directory private to a current accessing processing node.

FIG. 10 is a flowchart illustrating an exemplary process for managing a region-based probe filter directory.

FIG. 11 is a flowchart illustrating another exemplary process for managing a region-based probe filter directory.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to probe filters for enhancing cache coherency in a computing system. Specifically, the disclosed probe filters include a region-based probe filter directory that maintains its directory entry private by automatically shooting down or evicting previous owners (processing nodes) of cached data tracked by the directory entry, and making the directory entry solely track a new owner of the cached data.

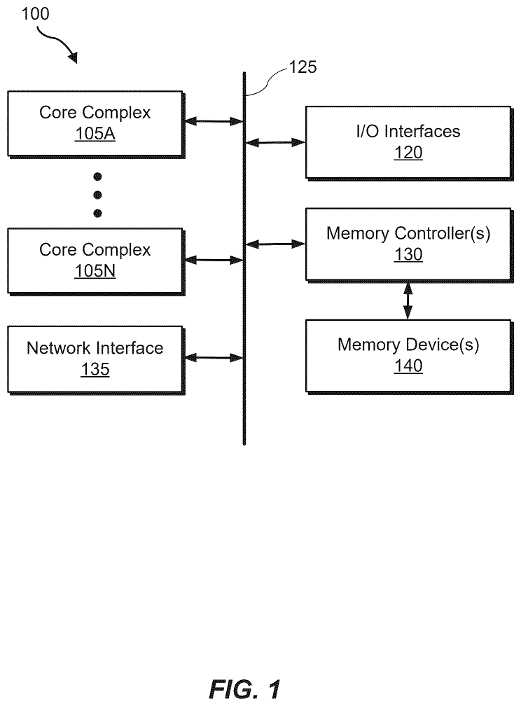

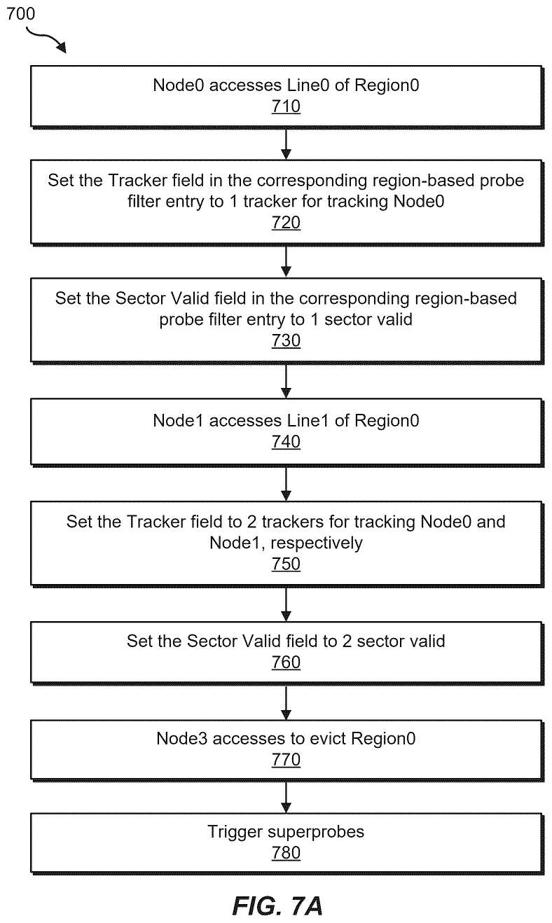

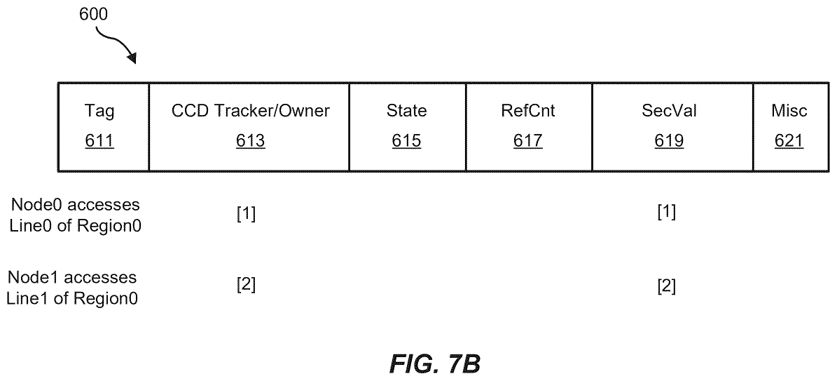

The following will provide, with reference to FIGS. 1-6, detailed descriptions of example systems for probe filter directory. Detailed descriptions of corresponding computer-implemented methods will also be provided in connection with FIGS. 7-11.

An exemplary computing system and method includes a probe filter directory having a directory entry for tracking cached data from a region of the memory, and a probe filter controller configured to automatically evict a first processing node from the directory entry without receiving a corresponding eviction instruction from a processing node in order to track a second processing node in the directory entry in response to the second processing node accessing the cached data, wherein the directory entry tracks only one processing node at a time.

In an implementation, the above directory entry tracks two or more processing nodes before the eviction and the above probe filter controller evicts all the tracked processing nodes from the directory entry before tracking the second processing node.

In another implementation, the probe filter controller evicts the first processing node without first sending a probe to the first processing node.

In another implementation, a capacity of the above probe filter directory is lower than a predetermined threshold.

In another implementation, the directory entry includes a sector valid field for indicating a number of tracked sectors in the region of the memory.

In an implementation, the above first processing node is a compute express link (CXL) type of device while the above second processing node is a central processing unit (CPU) type of device.

FIG. 1 is a block diagram of an exemplary computing system 100. As illustrated in this figure, exemplary computing system 100 includes at least core complexes 105A-N, input/output (I/O) interfaces 120, bus 125, memory controller 130, network interface 135, and memory device 140. In other implementations, computing system 100 can include other components and/or computing system 100 can be arranged differently. In an implementation, each core complex 105A-N includes one or more general purpose processors, such as central processing units (CPUs). It is noted that a “core complex” can also be referred to as a “processing node” a “CPU”, a “processor”, or an “accelerator” herein. In some implementations, one or more core complexes 105A-N can include a data parallel processor with a highly parallel architecture. Examples of data parallel processors include graphics processing units (GPUs), digital signal processors (DSPs), field programmable gate arrays (FPGAs), application specific integrated circuits (ASICs), and so forth. Each processor core within core complex 105A-N includes a cache subsystem with one or more levels of caches. In an example, each core complex 105A-N includes a cache (e.g., level three (L3) cache) which is shared between multiple processor cores.

Memory controller(s) 130 are representative of any number and type of memory controllers accessible by core complexes 105A-N. Memory controller(s) 130 are coupled to any number and type of memory devices 140. Depending on implementations, the type of memory in memory devices 140 coupled to memory controllers 130 can include Dynamic Random Access Memory (DRAM), Static Random Access Memory (SRAM), NAND Flash memory, NOR Flash memory, Ferroelectric Random Access Memory (FeRAM), or other types.

I/O interfaces 120 are representative of any number and type of I/O interfaces (e.g., peripheral component interconnect (PCI) bus, PCI-Extended (PCI-X), PCI Express (PCIe) bus, gigabit Ethernet (GBE) bus, universal serial bus (USB)). Various types of peripheral devices can be coupled to I/O interface 120. Such peripheral devices include (but are not limited to) displays, keyboards, mice, printers, scanners, joysticks or other types of game controllers, media recording devices, external storage devices, network interface cards, and so forth.

In various implementations, computing system 100 can be a server, personal computer, laptop, mobile device, game console, streaming device, wearable device, or any of various other types of computing systems or devices. It is noted that the number of components in computing system 100 can vary from implementation to implementation. There can be more or fewer of each component than the number shown in FIG. 1. It is also noted that computing system 100 can include other components not shown in FIG. 1. Additionally, in other implementations, computing system 100 can be structured in other ways than shown in FIG. 1.

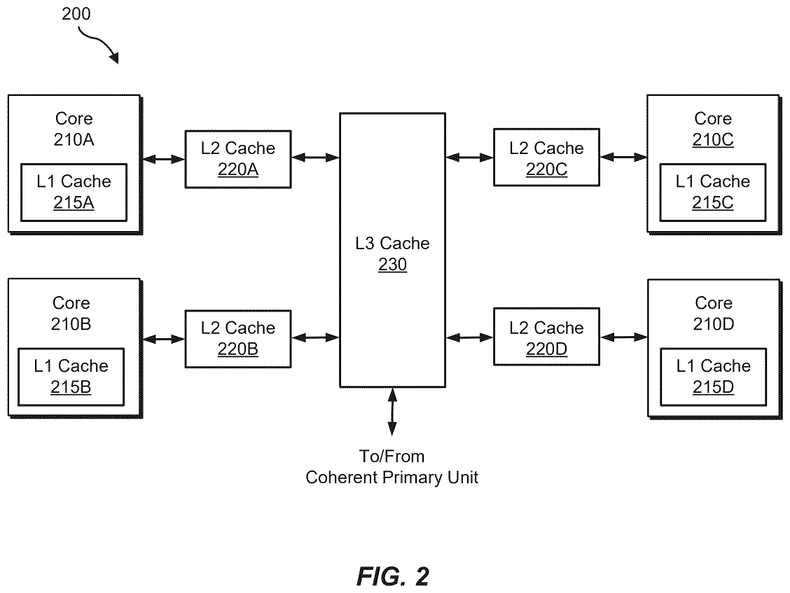

FIG. 2 is a block diagram of an exemplary core complex 200. In one implementation, core complex 200 includes four processor cores 210A-D. In other implementations, core complex 200 can include other numbers of processor cores. It is noted that a “core complex” can also be referred to as a “processing node”, “accelerator”, “processor” or “CPU” herein. In one example, the components of core complex 200 are included within core complexes 105A-N of FIG. 1.

Each processor core 210A-D includes a cache subsystem for storing data and instructions retrieved from the memory subsystem (not shown). For example, each core 210A-D includes a corresponding level one (L1) cache 215A-D. Each processor core 210A-D can include or be coupled to a corresponding level two (L2) cache 220A-D. Additionally, in one implementation, core complex 200 includes a level three (L3) cache 230 which is shared by the processor cores 210A-D exemplarily through L2 caches 220A-D. L3 cache 230 is also exemplarily coupled to a coherent master (not shown) for access to the fabric and memory subsystem. It is noted that in other implementations, core complex 200 can include other types of cache subsystems with other numbers of caches and/or with other configurations of the different cache levels.

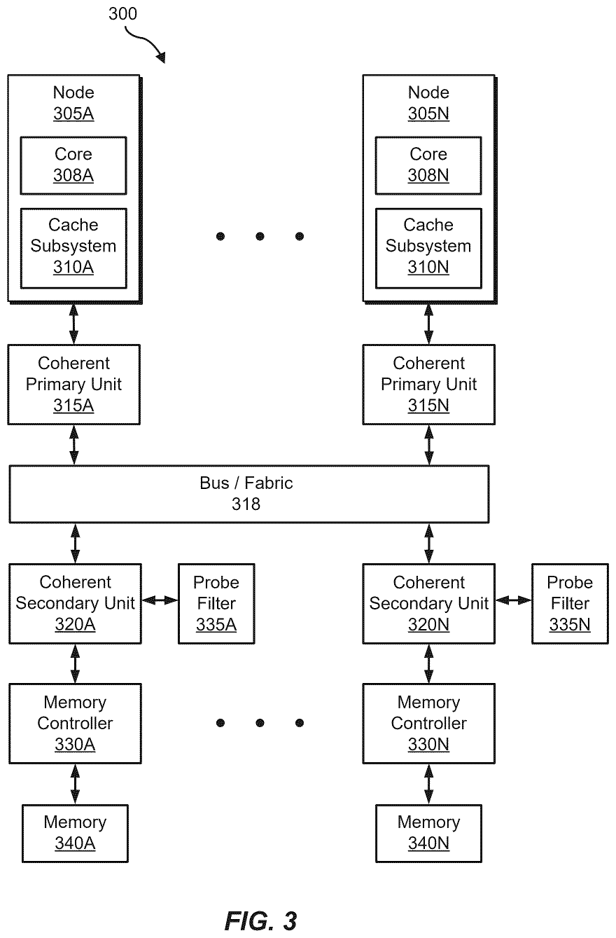

FIG. 3 is a block diagram of an exemplary multi-CPU system 300. System 300 includes multiple nodes 305A-N, with the number of nodes per system varying from implementation to implementation. Each node 305A-N can include any number of cores 308A-N, respectively, with the number of cores varying according to the implementation and from node to node. Each node 305A-N also includes a corresponding cache subsystem 310A-N, respectively. Each cache subsystem 310A-N can include any number of cache levels and any type of cache hierarchical structure.

In one implementation, each node 305A-N is coupled to a corresponding coherent primary unit 315A-N. As used herein, a “coherent primary unit” is defined as an agent that processes traffic flowing over an interconnect (e.g., bus/fabric 318) and manages coherency for a connected node. To manage coherency, a coherent primary unit 315A-N receives and processes coherency-related messages and probes and generates coherency-related requests and probes.

In one implementation, each node 305A-N is coupled to a corresponding coherent secondary (CS) unit 320A-N via a corresponding coherent primary unit 315A-N and bus/fabric 318. For example, node 305A is coupled through coherent primary unit 315A and bus/fabric 318 to coherent secondary unit 320A. Coherent secondary unit 320A is coupled to memory 340A via memory controller (MC) 330A. Coherent secondary unit 320A is also coupled to or includes probe filter 335A having entries for cache lines cached in system 300 for the memory 340A accessible through memory controller 330A. Probe filter 335A determines whether to issue a probe to at least one other processing node in response to a memory access request.

It is noted that probe filter 335A, and each of the other probe filters, can also be referred to as a “cache directory”. It is also noted that the example of having one memory controller per node is merely indicative of one implementation. It should be understood that in other implementations, each node 305A-N can be connected to other numbers of memory controllers.

In a similar configuration to that of node 305A, node 305N is coupled to coherent secondary units 320N via coherent primary unit 315N and bus/fabric 318. Coherent secondary unit 320N is coupled to or includes probe filter 335N for coherency purposes, and coherent secondary unit 320N is coupled to memory 340N via memory controllers 330N. As used herein, a “coherent secondary unit” is defined as an agent that manages coherency by processing received requests and probes that target a corresponding memory controller. Additionally, as used herein, a “probe” is defined as a message passed from a coherency point to one or more caches in the computer system 300 to determine if the caches have a copy of a block of data and optionally to indicate the state into which the cache should place the block of data and/or trigger a write-back of dirty data in the cache.

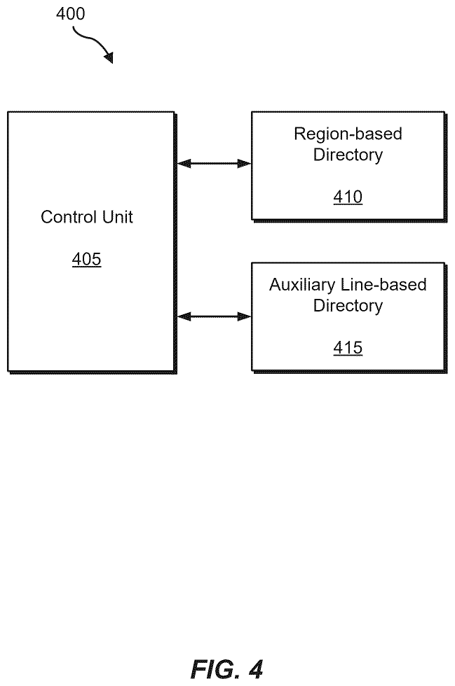

FIG. 4 is a block diagram of implementation of a probe filter 400. In this implementation, probe filter 400 includes at least control unit 405 (e.g., a controller or circuitry) coupled to region-based probe filter directory 410 (e.g., a data structure) and auxiliary line-based directory 415 (e.g., a data structure). Region-based probe filter directory 410 includes entries to track cached data on a region-basis. In one implementation, each entry of region-based probe filter directory 410 includes a reference count to count the number of accesses to cache lines of the region that are cached by the cache subsystems of the computing system (e.g., system 300 of FIG. 3). In one implementation, when the reference count for a given region reaches a threshold, the given region will start being tracked on a line-basis by auxiliary line-based directory 415.

In one implementation, only shared regions that have a reference count greater than a threshold will be tracked on a cache line-basis by auxiliary line-based directory 415. A shared region refers to a region that has cache lines stored in cache subsystems of at least two different CPUs. A private region refers to a region that has cache lines that are cached by only a single CPU. Accordingly, in one implementation, for shared regions that have a reference count greater than a threshold, there will be one or more entries in the line-based directory 415. In this implementation, for private regions, there will not be any entries in the line-based directory 415.

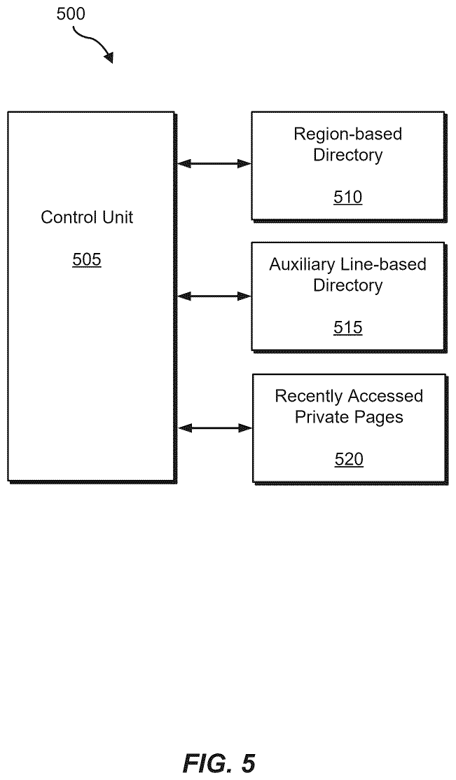

FIG. 5 is a block diagram of another implementation of a probe filter directory 500. In this implementation, probe filter directory 500 includes control unit 505 (e.g., a controller or circuitry), region-based probe filter directory 510 (e.g., a data structure), auxiliary line-based directory 515 (e.g., a data structure), and recently accessed private pages 520 for caching the N most recently accessed private pages. It is noted that N is a positive integer which can vary according to different implementations.

In one implementation, recently accessed private pages 520 includes storage locations to temporarily cache entries for the last N visited private pages. When control unit 505 receives a memory request or invalidation request that matches an entry in recently accessed private pages 520, control unit 505 is configured to increment or decrement the reference count, modify the cluster valid field and/or sector valid field, etc. outside of the directories 510 and 515. Accordingly, rather than having to read and write to entries in directories 510 and 515 for every access, accesses to recently accessed private pages 520 can bypass accesses to directories 510 and 515. The use of recently accessed private pages 520 can help speed up updates to probe filter directory 500 for these private pages.

In one implementation, I/O transactions that are not going to modify the sector valid or the cluster valid bits can benefit from recently accessed private pages 520 for caching the N most recently accessed private pages. Typically, I/O transactions will only modify the reference count for a given entry, and rather than performing a read and write of directory 510 or 515 each time, recently accessed private pages 520 can be updated instead.

Accordingly, recently accessed private pages 520 enables efficient accesses to the probe filter directory 500. In one embodiment, incoming requests perform a lookup of recently accessed private pages 520 before performing lookups to directories 510 and 515. In one embodiment, while an incoming request is allocated in an input queue of a coherent slave (e.g., coherent secondary unit 320A of FIG. 3), control unit 505 determines whether there is a hit or miss in recently accessed private pages 520. Later, when the request reaches the head of the queue, control unit 505 already knows if the request is a hit in recently accessed private pages 520. If the request is a hit in recently accessed private pages 520, the lookup to directories 510 and 515 can be avoided.

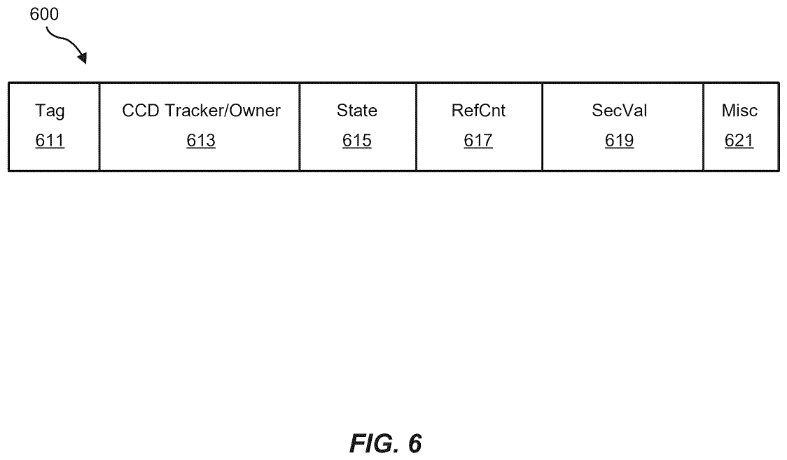

FIG. 6 is a block diagram of an implementation of a directory entry in a region-based probe filter directory. In this implementation, a region-based probe filter directory (not shown) includes a directory entry 600 which includes a tag field 611, a core complex die (CCD) tracker/owner field 613, a state field 615, a reference count (RefCnt) field 617, a sector valid (SecVal) field 619, and a miscellanea (Misc) field 621. In other implementations, the entries of the region-based probe filter directory can include other fields and/or can be arranged in other suitable manners.

Referring again to FIG. 6, tag field 611 includes the tag bits that are used to identify the entry associated with a particular cached memory region.

CCD tracker/owner field 613 is used to track the directory entry 600 to core complexes which own the cached data identified by the directory entry 600.

State field 615 includes state bits that specify the aggregate state of the region. The aggregate state reflects the most restrictive cache line state for this particular region. For example, the state for a given region is stored as “dirty” even if only a single cache line for the entire given region is dirty. Also, the state for a given region is stored as “shared” even if only a single cache line of the entire given region is shared.

Reference count field (RefCnt) 617 is used to track the number of cache lines of the region which are cached somewhere in the system. On the first access to a region, an entry is installed in region-based probe filter directory and the reference count field 617 is set to one. Over time, each time a cache accesses a cache line from this region, the reference count is incremented. As cache lines from this region get evicted by the caches, the reference count decrements. Eventually, if the reference count reaches zero, the entry is marked as invalid, and the entry can be reused for another region. By utilizing the reference count field 617, the incidence of region invalidate probes can be reduced. The reference count filed 617 allows directory entries to be reclaimed when an entry is associated with a region with no active subscribers. In one embodiment, the reference count field 617 can saturate once the reference count crosses a threshold. The threshold can be set to a value large enough to handle private access patterns while sacrificing some accuracy when handling widely shared access patterns for communication data.

Sector valid field (SecVal) 619 stores a bit vector corresponding to sub-groups or sectors of lines within the region to provide fine grained tracking. By tracking sub-groups of lines within the region, the number of unwanted regular coherency probes and individual line probes generated while unrolling a region invalidation probe can be reduced. As used herein, a “region invalidation probe” is defined as a probe generated by the probe filter directory in response to a region entry being evicted from the probe filter directory. When a coherent master receives a region invalidation probe, the coherent master invalidates each cache line of the region that is cached by the local CPU. Additionally, tracker and sector valid bits are included in the region invalidate probes to reduce probe amplification at the CPU caches.

The organization of sub-groups and the number of bits in sector valid field 619 can vary according to the implementation. In one implementation, two lines are tracked within a particular region entry using sector valid field 619. In another implementation, other numbers of lines can be tracked within each region entry. In this implementation, sector valid field 619 can be used to indicate the number of partitions that are being individually tracked within the region. Additionally, the partitions can be identified using offsets which are stored in sector valid field 619. Each offset identifies the location of the given partition within the given region. Sector valid field 619, or another field of the entry, can also indicate separate owners and separate states for each partition within the given region.

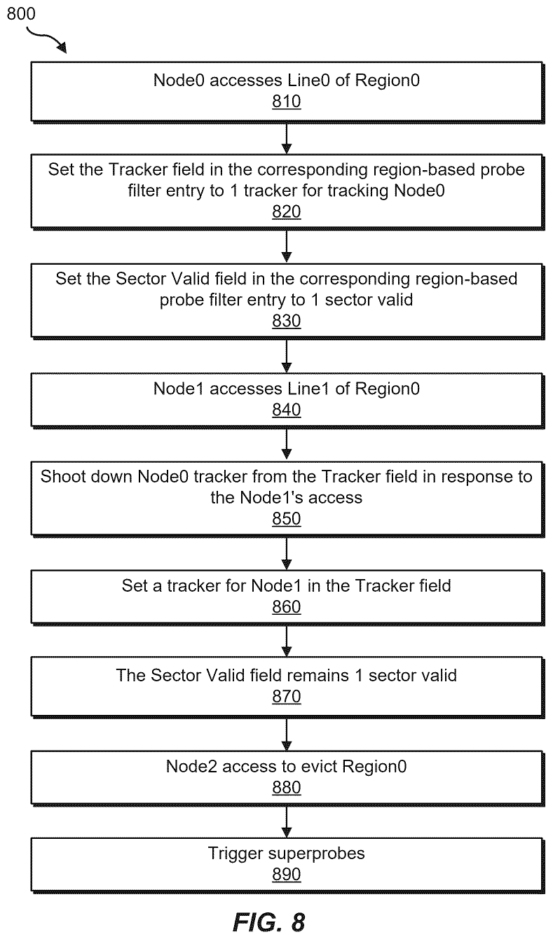

As described herein, a region-based probe filter directory (e.g., region-based directory 510) can track whether a region is “shared” by multiple processing nodes, which can reduce a number of entries needed for tracking lines (e.g., by tracking the region rather than individual lines). However, as described above, even if multiple processing nodes each access different lines of a region without overlap in access, a probe filter (e.g., control unit 505) can track the region itself as shared, leading to false sharing in which the corresponding directory entry indicates the lines of the region are shared when none of the individual lines are actually shared. Thus, certain probe filter activities can exhibit probe amplification, in which multiple probes are required based on the assumption that each of the lines are shared (which are unnecessary as the lines are not truly shared). The systems and methods herein address such probe amplification (e.g., as described with respect to FIG. 7) with a probe optimization. More specifically, as will be described further with respect to FIG. 8, the systems and methods herein provide shootdown (e.g., eviction) for a region probe filter to maintain entries as private as opposed to converting entries to shared.

FIG. 7A is a flowchart illustrating an exemplary process 700 for constructing a probe filter directory entry. In block 710, an exemplary processing node, Node0, accesses a line, Line0, of a region, Region0. In response, the probe filter sets a Tracker field for tracking Node0 in a region-based probe filter entry corresponding to Region0 in block 720. In block 730, the probe filter also sets a Sector Valid field to 1 sector valid in the corresponding region-based probe filter entry. It is 1 sector valid because a line maps to a single sector. When Node 1 touches a different line, it can or cannot set another sector valid depending on whether the old Line0 and the new Line1 map to the same sector or not. In block 740, another processing node, Node1, accesses another line, Line1, of Region0. In response, the probe filter sets the Tracker field to 2 trackers for tracking both Node0 and Node1, respectively, as shown in block 750. In block 760, the probe filter sets the Sector Valid field to 2 sector valid, for example, because line1 maps to a second sector. In block 770, when another processing node, Node3, accesses to evict Region0 including both Line0 and Line1, superprobes will be trigger in block 780. In some implementations, a superprobe corresponds to eviction/shootdown probes sent to every processing node grouped with a tracked node, which can further propagate (e.g., to regions, sectors, lines, etc.) as needed. Because the region-based probe filter director entry currently tracks two processing nodes, Node0 and Node1, the superprobes include 16 probes as a result of 2 trackers (e.g., for Node0 in Region0 and Node1 in Region0) times 2 processing node cache hierarchies (or CCDs) per tracker (e.g., Node0 and Node1 as probes are sent to each node in a group) times 2 sectors and times 2 lines per sector. Such large number of probes being triggered through trackers, regions and nodes reflects a probe amplification, and more specifically, exponential growth of a number of probes. When the ownership is private, the superprobes include only 2 probes as a result of 1 tracker times 1 owner times 1 sector and times 2 lines per sector.

FIG. 7B is a block diagram illustrating changing contents of a region-based probe filter directory entry in response to node accesses shown in FIG. 7A. When Node0 access Line0 of Region0 in block 710 shown in FIG. 7A, the Tracker field 613 in the corresponding region-based probe filter entry 600 is set to 1 tracker for tracking Node0, while the Sector Valid filed 619 is set to 1 for indicating 1 sector being valid. When Node1 accesses Line1 of Region0 in block 740 shown in FIG. 7A, the Tracker field 613 of the probe filter entry 600 is set to 2 trackers for tracking Node0 and Node1, respectively, while the Sector Valid field is set to 2 indicating 2 sectors being valid.

FIG. 8 is a flowchart illustrating another exemplary process 800 for constructing a probe filter directory entry. In an implementation, process 800 begins with Node0 accesses Line0 of Region0 in block 810. In response, the probe filter sets a Tracker field to 1 tracker for tracking Node0 in the region-based probe filter entry corresponding to Region0 in block 820. The probe filter also sets a Sector Valid field to 1 sector valid in the region-based probe filter entry in block 830. In block 840, a new processing node, Node1 accesses another line, Line1, of Region0. In response, the probe filter shoots down Node0 tracker from the tracker field in block 850. In doing so, Node0 is evicted from the region-based probe filter directory entry. In block 860, the probe filter sets a tracker for Node1 in the tracker field of the directory entry. As the directory entry is private to Node1, the Sector Valid field remains 1 sector valid in block 870. In block 880, when another processing node, Node3, accesses to evict Region0, superprobes will be trigger in block 890. Because the region-based probe filter director entry is private to Node1, the superprobes include just 2 total probes (e.g., shootdown probe for Node0 in Region0 and flattened superprobe for evicting Region0) due to operations at block 850 and block 880. Process 800 corresponds to keeping regions private as opposed to shared, for instance by keeping Region0 tracked as private to the most recently access node Node1 as opposed to having Region0 tracked as shared by Node1 and Node0. This reprivatization of Region0 requires an additional probing step at block 850 (as opposed to process 700). However, because the superprobe for eviction at block 880 is for a private region, probe amplification (as experienced in process 700 having Region0 tracked as shared) can be avoided. Therefore, process 800 significantly reduces a total number of probes in comparison with process 700 shown in FIG. 7 (e.g., causing a linear growth of a number of probes with the added shootdown, as opposed to the exponential growth of the number of probes due to probe amplification).

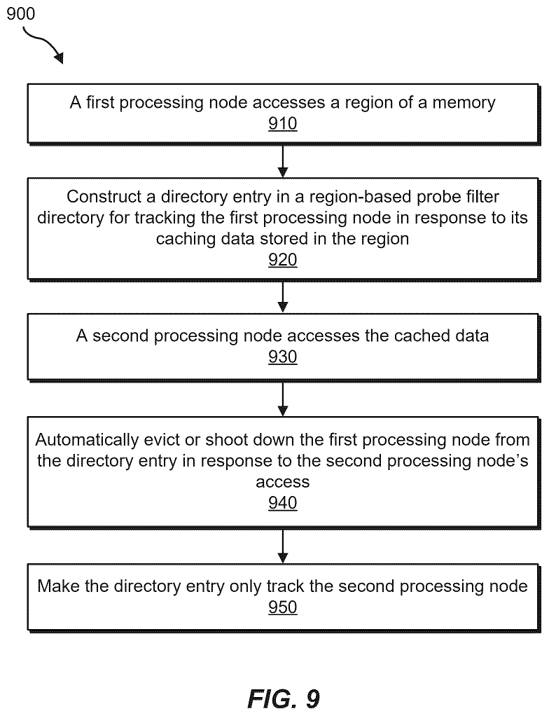

FIG. 9 is a flowchart illustrating an exemplary process 900 for maintaining a directory entry in a region-based probe filter directory (e.g., 410 of FIG. 4 and 510 of FIG. 5) private to a current accessing processing node. Process 900 begins with block 910 in which a first processing node (e.g., node 305A) accesses a region of a memory (e.g., memory 340A). In response to caching data stored in the region by the first processing node, a probe filter controller (e.g., control unit 505) constructs a directory entry (e.g., 600 of FIG. 6) in a region-based probe filter directory (e.g., region-based directory 510) for tracking the first processing node as an owner of the data in block 920. When a second processing node (e.g., node 350N) accesses the cached data in block 930, the probe filter controller automatically evicts or shoots down the first processing node from the directory entry in response to the second processing node's access in block 940, which in some examples prevents marking the region of the memory as shared. The probe filter controller then makes the directory entry track the second processing node in block 950, which in some examples includes keeping the region of the memory private. As a result of process 900, the directory entry tracks only one processing node that is the latest in accessing the cached data during a lifetime of the directory entry.

It is noted that the probe filter controller is programmed to automatically or act on its own to evict a previous owner of cached data from the directory entry for solely tracking a new owner. It is distinguished from other type of evictions in which the probe filter controller has to receive an instruction from the corresponding processing node to carry out an eviction. In an implementation, the automatically eviction does not trigger a probing of the previous owner. In this way, the gain from maintaining a directory entry and corresponding region private is at a cost of losing tractions of previous caching operations, therefore, such automatic eviction should only be conducted under certain circumstances, such as the previous owner's access is stale, or the region-based probe filter directory has limited capacity and there are shared pages among the directory entries.

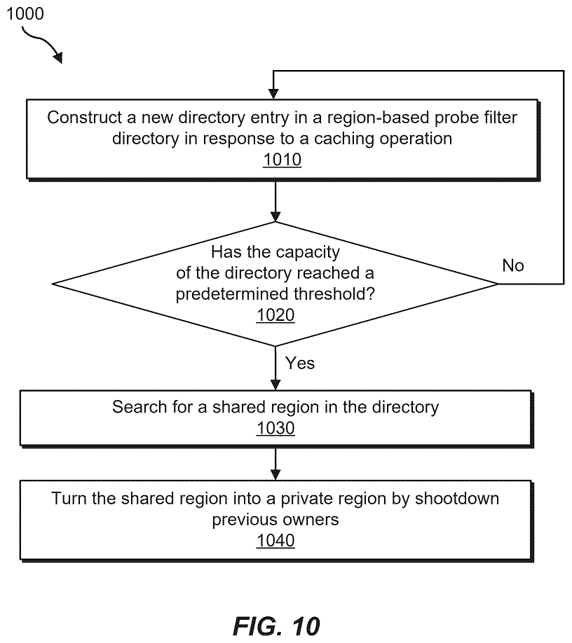

FIG. 10 is a flowchart illustrating an exemplary process 1000 for managing a region-based probe filter directory. Process 1000 begins with constructing a new directory entry in a region-based probe filter directory (e.g., 410 of FIG. 4) in response to a caching operation in block 1010. In block 1020, the probe filter (e.g., 335A of FIG. 3) inquires a capacity of the region-based probe filter directory. If the capacity is lower than a predetermined threshold, process 1000 proceeds to search for a shared region in the region-based probe filter directory in block 1030. When such shared region is found, the probe filter shoots down, or evicts previous owners to the region and makes the region private to the new accessing processing node in block 1040. If the capacity has not reached the predetermined threshold, process 900 returns to block 1010 and constructs new directory entry for a new accessing processing node. In an implementation, the threshold is set at a half of a full capacity of the region-based probe filter directory. In another implementation, the threshold is dynamically adjusted based on performance of computing system.

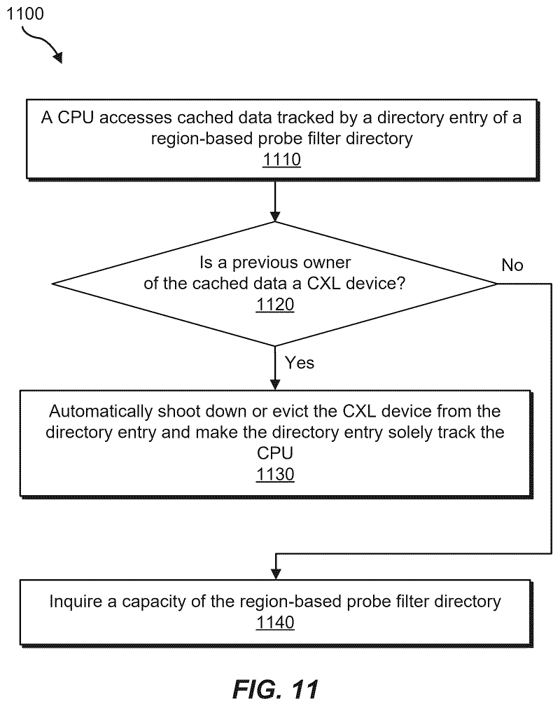

FIG. 11 is a flowchart illustrating another exemplary process 1100 for managing a region-based probe filter directory (e.g., 410 of FIG. 4). Process 1100 begins with a CPU type of processing node accesses cached data tracked by a directory entry of a region-based probe filter directory in block 1110. In block 1120, process 1100 inquires if a previous owner of the cached data is a compute express link (CXL) type of processing node, such as a graphic accelerator or a cryptographic accelerator. If that is the case, process 1100 automatically shoots down or evicts the CXL device from the directory entry and makes the directory entry solely track the CPU device in block 1130, because CXL device is exemplarily considered of lower priority to the CPU device. Otherwise, e.g., the previous owner is also a CPU device, process 1100 inquires a capacity of the region-based probe filter directory in block 1140, and makes an eviction decision based on an inquiry result in accordance with process 1000 shown in FIG. 10.

The present disclosure discloses a region-based probe filter directory maintains its directory entry private by automatically shooting down or evicting previous owners (processing nodes) of cached data tracked by the directory entry, and making the directory entry solely track a new owner of the cached data.

By keeping directory entries of a region-based probe filter directory private, probe amplification can be avoided, i.e., super-probes are far less triggered. Reducing shared entries in the region-based probe filter directory can also help maintain the capacity thereof. By using line probe optimization (shooting down old owner of a page), cache coherency can be achieved without relying on reference count which may not always be fully decremented to zero. Further, the described shoot-downs can limit super-probe growth to a linear factor (e.g., requiring additional super-probes to perform the shoot down), whereas probe amplification from shared pages can cause exponential growth.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed. Any of the various compute systems described herein are configured to implement processes described herein.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device comprising:
a probe filter directory having a directory entry for tracking cached data from a region of a memory; and
a probe filter controller configured to evict a first processing node from the directory entry in order to track a second processing node in the directory entry in response to the second processing node accessing the cached data.

2. The device of claim 1, wherein the directory entry tracks only one processing node at a time.

3. The device of claim 1, wherein the probe filter controller automatically evicts the first processing node without receiving a corresponding eviction instruction from a processing node.

4. The device of claim 1, wherein the directory entry tracks two or more processing nodes before the eviction and the probe filter controller evicts all the tracked processing nodes from the directory entry before tracking the second processing node.

5. The device of claim 1, wherein the probe filter controller evicts the first processing node without first sending a probe to the first processing node.

6. The device of claim 1, wherein a capacity of the probe filter directory is lower than a predetermined threshold.

7. The device of claim 1, wherein the directory entry includes a tracker field for identifying either the first or second processing node.

8. The device of claim 1, wherein the directory entry includes a sector valid field for indicating a number of tracked sectors in the region of the memory.

9. The device of claim 1, wherein the directory entry includes a tag field pointing to the region of the memory.

10. The device of claim 1, wherein the first processing node is a compute express link (CXL) type of device while the second processing node is a central processing unit (CPU) type of device.

11. A system comprising:
a first and second processing nodes each including one or more processors and a cache subsystem for caching data;
a probe filter directory having a directory entry for tracking cached data from a region of a memory; and
a probe filter controller configured to evict the first processing node from the directory entry in order to track the second processing node in the directory entry in response to the second processing node accessing the cached data,
wherein the directory entry tracks only one processing node at a time.

12. The system of claim 11, wherein the probe filter controller automatically evicts the first processing node without receiving a corresponding eviction instruction from a processing node.

13. The system of claim 11, wherein the probe filter controller evicts the first processing node without first sending a probe to the first processing node.

14. A method comprising:
tracking, in a directory entry of a probe filter directory for tracking cached data from a region of memory, a first processing node as having accessed the cached data;
evicting, by a probe filter controller, the first processing node from the directory entry of the probe filter directory in response to a second processing node accessing the cached data; and
tracking, by the probe filter controller, the second processing node in the directory entry in response to the second processing node accessing the cached data.

15. The method of claim 14, wherein the directory entry tracks only on processing node at a time.

16. The method of claim 14, wherein the probe filter controller automatically evicts the first processing node without receiving a corresponding eviction instruction from a processing node.

17. The method of claim 14, wherein the directory entry tracks two or more processing nodes before the eviction and the probe filter controller evicts all the tracked processing nodes from the directory entry before tracking the second processing node.

18. The method of claim 14, wherein the probe filter controller evicts the first processing node without first sending a probe to the first processing node.

19. The method of claim 14, wherein the directory entry includes a tracker field for identifying either the first or second processing node.

20. The method of claim 14, wherein the directory entry includes a sector valid field for indicating a number of tracked sectors in a region of the memory storing the cached data.
